(19) United States
(12) Patent Application Publication
(10) Pub. No.: US 2024/0252847 A1
(43) Pub. Date: Aug. 1, 2024

(54) FILTERING FACEPIECE RESPIRATOR WITH DIFFUSER

(71) Applicant: S.C.O.P.E. Medical, Inc., Brunswick, OH (US)

(72) Inventor: Tosan A. Ugbeye, Brunswick, OH (US)

(73) Assignee: S.C.O.P.E. Medical, Inc., Brunswick, OH (US)

(21) Appl. No.: 18/428,811

(22) Filed: Jan. 31, 2024

Related U.S. Application Data
(60) Provisional application No. 63/482,419, filed on Jan. 31, 2023.

(51) Int. Cl. A62B 7/10; A62B 23/02

(52) U.S. Cl. CPC A62B 7/10; A62B 23/025

(57) ABSTRACT

Provided is a respirator. The respirator includes a mask body having an anterior side portion, a posterior side portion, a middle portion, a first side portion, a second side portion, a top side portion, a bottom side portion and outer edge portions. The respirator further includes a diffuser allowing for the delivery of oxygen to the patient and the removal of carbon dioxide from the space between the patient's face and the posterior side of the mask body as the patient exhales. The respirator further includes various seals and filter media positioned over apertures or ports within the mask body. The seals and filter media are removable to provide additional access to the patient and to also allow for the connection of medical instruments to the mask.

### TECHNICAL FIELD

The present inventive disclosure is directed to various embodiments of a filtering facepiece respirator, also referred to herein as a mask and associated methods. The filtering facepiece respirator functions to provide oxygen delivery and filtration ability to reduce aerosol, respiratory droplet and microbial spread. The claims of the present application and the disclosure set forth herein cover a product and process related to COVID-19 and such product and processes are subject to applicable FDA approval for COVID-19 use.

### BACKGROUND

The present invention relates to respirators, and more particularly to a filtering facepiece respirator mask (e.g., an N95 or other filtration rated mask) to be worn by patients during airway instrumentation, and a filtering facepiece respirator mask (e.g., N95 or other filtration rated mask) to be worn by patients before procedures, during airway instrumentation, and after procedures.

Healthcare workers are constantly exposed to respiratory droplets from patients whose airways have been instrumented by an endotracheal tube, laryngeal mask airway, endoscope and other medical devices.

Existing N95 respirator masks and other filtration rated masks do not protect clinicians from aerosolized respiratory droplets during instrumentation of the airway (for endoscopes), or during ventilation of the patient (for laryngeal mask airways and, to a lesser extent, endotracheal tubes), exposing both the patient and clinicians to viruses and other hazardous micro particles.

Aerosolization of respiratory droplets during ventilation constantly exposes everyone around a patient to said hazards, making breathing devices, especially laryngeal mask airways (that are not secured in the trachea and do not create complete seals around the trachea), dangerous to clinicians taking care of a ventilated patient.

Existing N95 respirator masks and other filtration rated masks do not work well because they have no way of creating a valid seal around the instrumenting device and the patient's face. As can be seen, there is a need for a solution to at least one of the aforementioned problems.

### BRIEF DESCRIPTION OF THE DRAWINGS

FIG. 1 is a perspective view of an exemplary embodiment of a filtering facepiece respirator with a diffuser.

FIG. 2 is a perspective view of an exemplary embodiment of a filtering facepiece respirator without a diffuser attached.

FIG. 3 is a perspective exploded view of an exemplary embodiment of a filtering facepiece respirator with the seals exploded.

FIG. 4 is a perspective exploded view of an exemplary embodiment of a filtering facepiece respirator with the transparent N95 filter membranes exploded.

FIG. 5 is a perspective exploded view of an exemplary embodiment of a filtering facepiece respirator with a diffuser.

FIG. 6 is a perspective view of an exemplary embodiment of a diffuser.

FIG. 7 is an perspective exploded view of an exemplary embodiment of a diffuser.

FIG. 8 is a cross-sectional view of an exemplary embodiment of a diffuser.

FIG. 9 is a perspective cross-sectional view of an exemplary embodiment of a diffuser.

FIG. 10 is a cross sectional view of an exemplary embodiment of a diffuser.

FIG. 11 is a perspective exploded top view of an exemplary embodiment of a diffuser.

FIG. 12 is a perspective exploded bottom view of an exemplary embodiment of a diffuser.

FIG. 13 is a perspective cross-sectional view of an exemplary embodiment of a diffuser.

FIG. 14 is a perspective cross-sectional view of an exemplary embodiment of a diffuser.

FIG. 15 is a perspective view of an exemplary embodiment of a diffuser.

FIG. 16 is a top view of an exemplary embodiment of a diffuser.

FIG. 17 is a bottom view of an exemplary embodiment of a diffuser.

FIG. 18 is a perspective front view of an exemplary embodiment of a diffuser.

FIG. 19 is a first perspective bottom view of an exemplary embodiment of a diffuser.

FIG. 20 is a second perspective bottom view of an exemplary embodiment of a diffuser.

FIG. 21 is a perspective top view of an exemplary embodiment of a diffuser.

FIG. 22 is a front view of an exemplary embodiment of a respirator.

FIG. 23 is a first perspective side view of an exemplary embodiment of a respirator.

FIG. 24 is a first side view of an exemplary embodiment of a respirator.

FIG. 25 is a second side view of an exemplary embodiment of a respirator.

FIG. 26 is a second perspective side view of an exemplary embodiment of a respirator.

FIG. 27 is a first rear perspective side view of an exemplary embodiment of a respirator.

FIG. 28 is a rear view of an exemplary embodiment of a respirator.

FIG. 29 is a top view of an exemplary embodiment of a respirator.

FIG. 30 is a bottom view of an exemplary embodiment of a respirator.

FIG. 31 is a second rear perspective side view of an exemplary embodiment of a respirator.

### DETAILED DESCRIPTION

The following detailed description is of the best currently contemplated modes of carrying out exemplary embodiments of a filtering facepiece respirator and diffuser combination and of a stand-alone diffuser. The description is not to be taken in a limiting sense but is made merely for the purpose of illustrating the general principles of the present invention.

Broadly, an embodiment of the present disclosure provides a filtering facepiece respirator mask to be worn by patients before procedures, during airway instrumentation, and after procedures.

The filtering facepiece respirator includes designs for various types of uses including Endotracheal Tube (ETT) placement while the mask is on, ETT extubation with the mask on and maintenance while the ETT is in place, Laryngeal Mask Airway (LMA) placement while the mask is on, LMA removal with the mask on and maintenance while the LMA is in place, Aerosol generating procedures (AGPs) including but not limited to EGDs, bronchoscopies, TEE placement and other medical scopes. The mask may be used for procedures where there is access to the patient's face including procedures that require no sedation, some sedation and Monitored Anesthesia Care (MAC). The mask may be used for procedures which require patients to wear a mask before procedures to protect the patient (protection function) and to protect providers and other people around the patient (isolation function), for oxygen supplementation during procedures and during recovery. The mask may also provide breathing detection and other vital signs monitoring by attaching accessories to the ports within the mask.

Various exemplary embodiments of the present disclosure provide a solution to several problems. Healthcare workers are constantly exposed to respiratory droplets from patients whose airways have been instrumented by an endotracheal tube, laryngeal mask airway, endoscope and other medical devices. The respirator mask may be placed on the patient prior to the medical procedure providing protection to both the patient and the clinician. The respirator mask creates a full seal around the patient's face after instrumentation of the airway.

Existing N95 respirator masks and masks of other filtration ratings do not protect clinicians from aerosolized respiratory droplets during instrumentation of the airway (for endoscopes), or during ventilation of the patient (for laryngeal mask airways and, to a lesser extent, endotracheal tubes), exposing both the patient and clinicians to viruses and other hazardous micro particles. Aerosolization of respiratory droplets during ventilation constantly exposes everyone around a patient to said hazards, making breathing devices, especially laryngeal mask airways (that are not secured in the trachea and do not create complete seals around the trachea), dangerous to clinicians taking care of a ventilated patient. The respirator mask disclosed herein distinguishes over the previously available devices by creating additional filter/sealing layers around both the instrumenting device and the patient's face.

The respirator mask disclosed herein is placed on the patient (preferably prior to the procedure), protects both the patient and the clinician prior to the procedure, and creates a full seal around the patient's face after instrumentation of the airway. The mask also allows for multiple adapters to be used for administration of oxygen, measuring CO₂, providing expiratory pressure for stenting open airways and more.

During periods of heightened awareness like during flu season, or other viral or bacterial outbreaks, surgical masks maybe placed on patients in the hospital to mitigate the spread of infectious droplets. However, while these masks may protect others, they do not offer optimal protection for the patients as they do not filter out viruses and other smaller harmful particles.

This mask serves several purposes by keeping both the patients and the whole hospital protected while they are awaiting procedures. The mask keeps patients and clinicians protected during airway instrumenting procedures. It also keeps patients and the entire hospital protected after the procedures, while providing functional features including but not limited to oxygen delivery, positive pressure to assist breathing, spirometry, nebulized medication delivery etc.

In an exemplary embodiment, provided is an adjustable respirator mask which has a microfiber filter that prevents inhalation of micro particles, including viruses. The mask may have a filtration rating of N95 or a rating in accordance with any other filtration standard within the industry. The mask includes a middle portion which includes an attachable circular or circular-like piece. In certain embodiments, the circular or circular-like piece may include a detachable exhalation and inhalation valve.

The filtering facepiece respirator provides several benefits over existing respirators. First, the filtering facepiece respirator remains on a patient's face during a medical procedure to reduce the amounts of droplets in the air from aerosol generating procedures. Second, because the respirator need not be removed from the patient's face when inserting or removing a medical instrument into or out the buccal cavity, the respirator offers a seamless transition from the waiting room to the procedure room and through the recovery room and outside the hospital. The respirator also provides a novel aperture/base unit on the front of the mask that allows for attachment of a multitude of devices with varying functions across several industries.

The filtering facepiece respirator is also capable of providing the utility and convenience of existing respirator masks (including that of N95 respirator masks), while also providing a novel slot for medical instruments in the oropharynx, and additional silicone layers for enhanced sealing around the lumen of medical instruments and around the patient's face.

While some existing N95 masks may already come with exhalation valves, the filtering facepiece respirator disclosed herein provides a universe of additional functionality in that exhalation/inhalation valves may be detached in particular situations, and a variety of different complementary accessory devices may be attached to the mask. The exhalation/inhalation valve and complementary accessory devices are thus interchangeable with the orifices on the mask. Such complementary accessory devices may be used for delivering oxygen, delivering nebulized medications, taking breath samples and CO₂ monitoring.

Provided is a filtering facepiece respirator including a diffuser and associated methods. Also provided is a stand-alone diffuser separate from the filtering facepiece respirator and associated methods.

The filtering facepiece respirator includes a mask body having an anterior side, a posterior side, a middle portion, a first side portion, a second side portion, a top side portion, a bottom side portion and outer edge portions. The filtering facepiece respirator further includes at least one port (which may be referred to as a primary port) that is positioned on the mask body (allowing a pathway between the anterior and posterior side of the mask body) and a diffuser that is fitted through the port on the mask body. The diffuser allows for the passage of a fluid (for example, air) from the environment exterior of the mask body to the interior or posterior side of the mask body between the mask body and the patient wearing the respirator and from the interior or posterior side of the mask body between the mask body and the patient wearing the respirator and the environment exterior of the mask body. The port may be positioned at any location on the mask body including the anterior side, posterior side, middle portion, first side portion, second side portion, top side portion and bottom side portion of the mask body. According to certain aspects of the present teaching, the port is positioned at the middle portion of the mask and provides a pathway between the anterior and posterior sides of the mask body. According to further aspects of the present teaching, the port is positioned in a location in proximity to a patient's nasal and oral cavity when the respirator is worn by a patient.

The filtering facepiece respirator may include additional ports or openings on the mask body. According to certain aspects of the present teaching, the filtering facepiece respirator may include at least one opening on one or both of the first side portion and the second side portion of the mask body. According to further aspects of the present teaching, the filtering facepiece respirator includes an opening on the first side portion and an opening on the second side portion of the mask body. Fitted over the openings on the first side portion and the second side portions of the mask body may be either a removable filter membrane, a seal and a seal including a self-closing opening, also referred to as a self-sealing opening. According to certain aspects of the present teaching, a removable filter membrane is positioned over the openings on the first side portion and the second side portion of the mask body. The removable filter membrane may be transparent. The removable filter membrane may be of N95 grade. The removable filter membrane may be transparent and of N95 grade. It is noted that the filter membrane, seal and seal including a self-closing or self-sealing opening positioned on the first and second side openings of the mask body are removable to allow for greater accessibility to the patient's oral and nasal cavities and facial regions if necessary.

According to further aspects of the present teaching, the filtering facepiece respirator may include at least one opening on at least one of the top side portion and the bottom side portion of the mask body. The openings that may be present on the top side portion and/or the bottom side portion of the mask body may be in addition to the openings that may be present on the first side portion and/or the second side portion of the mask body. In other embodiments, the mask body includes openings on the top side portion and bottom side portion of the mask body without openings on either the first side portion and/or the second side portion being present. According to certain aspects of the present teaching, the mask body includes an opening on the top side portion, an opening on the bottom side portion, an opening on the first side portion and an opening on the second side portion of the mask body. Fitted over the openings on the top side portion and the bottom side portions of the mask body may be either a removable filter membrane, a seal (membrane) and a seal (membrane) including a self-closing or self-sealing opening. The self-closing or self-sealing opening allows for an instrument or a portions of a medical provider's hand to be inserted through the opening while providing and maintaining a seal between the patient's facial region and the outside environment. According to certain aspects of the present teaching, the seal may have a very stretchy opening to allow for insertion of instruments and is capable of stretching to at least the size of a large human hand. Upon insertion of an instrument through the opening of the seal, the opening of the seal stretches to accommodate the insertion of the instrument and subsequently releases to the size of the instrument inserted through the opening forming a seal between the seal (membrane) and the instrument. According to further aspects of the present teaching, a seal including a self-closing opening is positioned over the openings on the top side portion and the bottom side portion of the mask body. It is noted that in other embodiments including a removable filter membrane, the removable filter membrane may be transparent. The removable filter membrane may be of N95 grade. The removable filter membrane may be transparent and of N95 grade. It is noted that the filter membrane, seal and seal including a self-closing or self-sealing opening positioned on the top and bottom side openings of the mask body may be removable to allow for greater accessibility to the patient's oral and nasal cavities and facial regions if necessary.

As mentioned above, the filtering facepiece respirator includes a diffuser that is engaged to a port on the mask body. In certain aspects of the present teaching, the diffuser is engaged to the primary port on the mask body. The mask body of the filtering facepiece respirator may, in certain embodiments, include a diffuser retaining boss to assist with securing the diffuser in place to the port on the mask body.

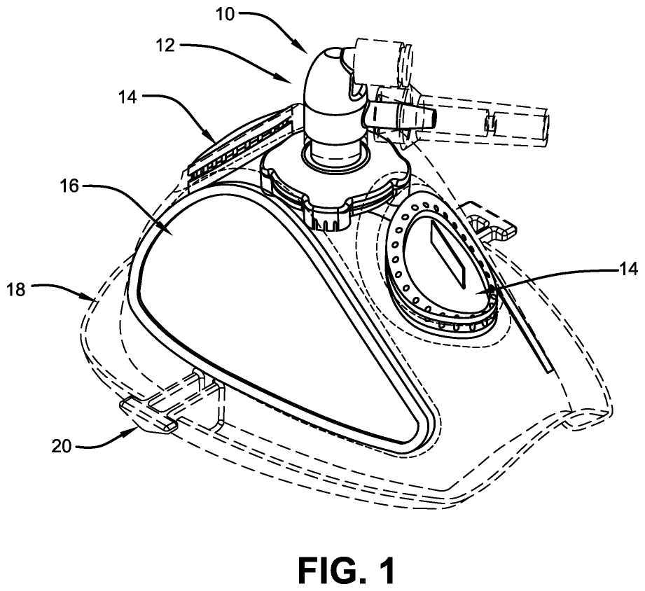

FIG. 1 illustrates an exemplary embodiment of a filtering facepiece respirator (10). The respirator (10) includes a face mask body (18) having an anterior side, a posterior side, a middle portion, a first side portion, a second side portion, a top side portion, a bottom side portion and an outer edge portion. According to certain aspects of the present teaching, the mask body (18) includes two side openings, i.e., a first side opening on a first side of the mask body (18) and a second side opening on a second side of the mask body (18). Each side opening is capable of housing a filter media, a filter membrane or a sealing membrane. According to certain aspects of the present teaching, each side opening houses a filter membrane (16) which may be rated N95. The filter membrane (16) may in certain embodiments be transparent. The filter membrane (16) is removable and various adapters may be attached to the opening in the top and bottom anterior portion of the mask body upon removal of the self-sealing membrane. Each side of the mask body (18) may include hooks (20) for securing a strap to secure the respirator over a patient's head. According to certain aspects of the present teaching, the strap hooks (20) may include two vertically-oriented members having a first end attached to the mask body (18) and a second end attached to a horizontally-oriented member. According to certain aspects of the present teaching, the top side anterior portion of the mask body (18) and/or the bottom side anterior portion of the mask body may include an aperture which may be circular in shape (although any shape deemed suitable to a person of ordinary skill in the art may be integrated into the mask body (18)). The aperture on the top side anterior portion and on the bottom side anterior portion of the mask body (18) is covered with a self-closing opening such as a self-sealing membrane (14). The self-sealing membrane (14) is removable and various adapters may be attached to the opening in the top and bottom anterior portion of the mask body upon removal of the self-sealing membrane. The middle anterior portion of the mask body (18) may include an aperture that is capable of housing a diffuser (12) which is used to assist with the inhalation of oxygen and exhalation of carbon dioxide to and from the patient.

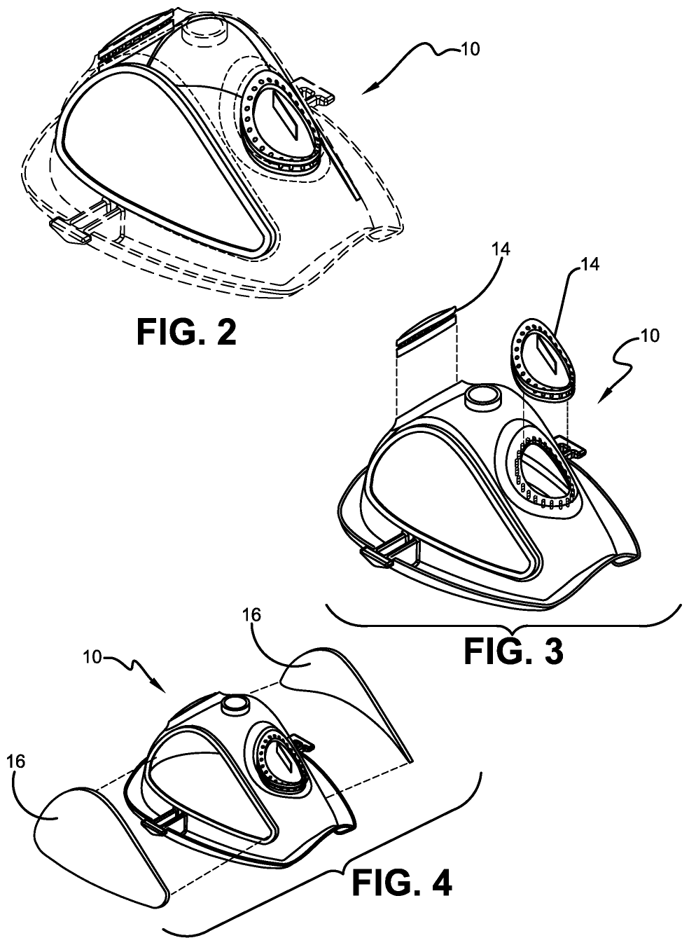

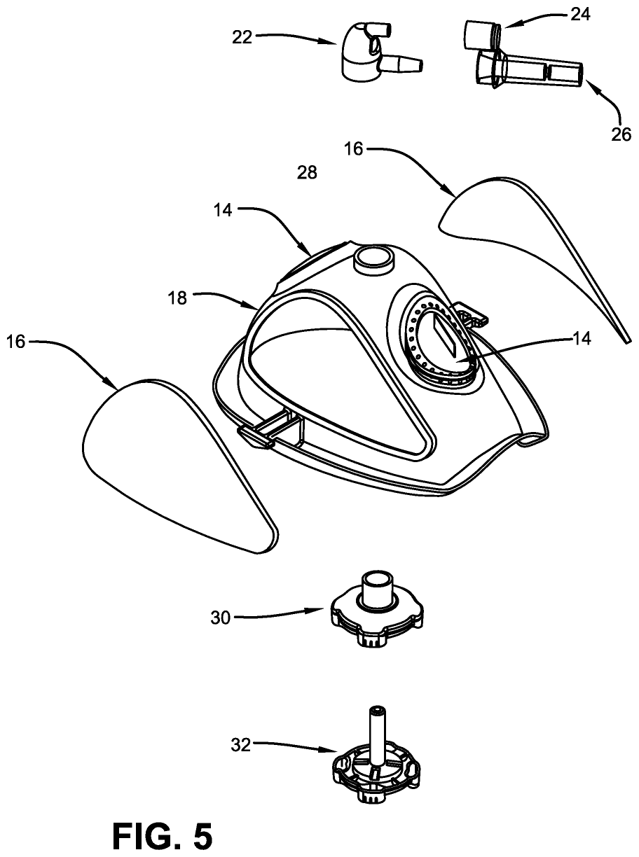

FIG. 2 illustrates the respirator of FIG. 1 without the diffuser (12) installed onto the mask body. As shown in FIG. 2, the diffuser (12) is attached to a diffuser retaining boss (28) (also shown in FIG. 5). FIG. 3 illustrates the respirator of FIG. 1 without the diffuser (12) and without the top or bottom anterior sealing membranes (14) installed onto the mask body (18). FIG. 4 illustrates the mask body (18) with the sealing-membranes (14) removed from the two side apertures and with the diffuser (12) from the aperture in the middle anterior portion of the mask.

As mentioned above, the diffuser allows for the passage of air between the exterior environment and the posterior side of the mask body. The diffuser includes an oxygen inlet port that allows for oxygen to enter the diffuser and pass through the primary port on the mask body to the posterior side of the mask body for inhalation by a patient and a carbon dioxide extraction luer port which allows for carbon dioxide exhaled by the patient at the posterior side of the mask body, entering into the diffuser and passing through the primary port of the mask body to exit to the exterior environment. Thus, the diffuser is a single unitary device that includes a dual functionality allowing for inhalation of oxygen and exhalation of carbon dioxide. The oxygen inlet port and the carbon dioxide luer port on the diffuser may be fitted respectively with an oxygen tube connector and a carbon dioxide luer port cap. According to certain aspects of the present teaching, the oxygen tube connector and carbon dioxide luer port cap may constitute a unitary device allowing for simultaneous engagement to the oxygen port and carbon dioxide luer port. The oxygen port tube connector allows the oxygen port to be connected to an oxygen tube for delivery of oxygen from an oxygen delivery device to a patient.

At a basic level, the diffuser includes a base portion (62) and a top portion (64) which are engaged to each other. With reference to FIGS. 7 through 10, the base portion of the diffuser includes a first conduit (66) which extends upward from the base portion and a second conduit (68) positioned within the first conduit (has a smaller sized opening and passageway than the first conduit) which extends upward from the base portion. The top portion of the diffuser (also referred to as the diffuser top body) includes a head portion (70) and a bottom portion (72). The interior of the top portion of the diffuser includes a receiving conduit (74) and a receiving flange (76). The receiving conduit (74) of the diffuser extends upward from the base portion (72) towards the head portion (70) of the top portion (64) of the diffuser. The receiving flange (76) may be integrated within the receiving conduit (74) of the top portion (64) of the diffuser and extends downward from the head portion (70) of the top portion (64) of the diffuser. The first conduit (66) of the base portion (62) of the diffuser engages the receiving conduit (74) of the top portion (64) of the diffuser. The second conduit (68) of the base portion (62) of the diffuser engages the receiving flange (76) which extends downward from the head portion (70) of the top portion (64) of the diffuser. This fit is illustrated within FIGS. 7 through 10 of the drawings. According to certain aspects of the present teaching, the bottom portion (62) of the diffuser is fitted onto the posterior side of the mask body in a manner that allows the first conduit (66) and the second conduit (68) of the base portion (62) of the diffuser to pass through the primary port on the mask body towards the anterior side of the mask body. The top portion (64) of the diffuser is fitted over the first conduit (66) and the second conduit (68) of the bottom portion of the diffuser at the anterior side of the mask body.

According to certain aspects of the present teaching, the top portion (64) and the base portion (62) of the diffuser are rotatable with respect to each other to accommodate medical personnel preference during treatment as well as patient preference. Rotation of the position of the top portion (62) with respect to the position of the base portion (64) of the diffuser may be lockable due to the presence of flanges and corresponding grooves in the interior side of the top portion (64) and the exterior side of the first conduit (66) of the base portion (62).

With further reference to FIGS. 7 through 10, the engagement between the first conduit (66) of the base portion (62) of the diffuser and the receiving conduit (74) of the top portion (64) of the diffuser forms an inlet passageway (78) that is communication with the oxygen port (36) allowing oxygen to be delivered to the patient on the posterior side of the mask body. More specifically, the inlet passageway (78) is formed from an inlet space provided between the first conduit (66) of the base portion (62) and the second conduit (68) of the base portion (62). This inlet space is enclosed at its top by the second conduit (68) of the base portion (62) engaging the receiving flange (76) which extends down from the head portion (70) of the top portion (64) of the diffuser. The top portion (64) of the diffuser includes an inlet port (36). The inlet port (36) provides an inlet passageway in communication with the inlet space provided between the first conduit (66) of the base portion (62) and the second conduit (68) of the base portion. The inlet passageway (78) is enclosed by the second conduit (68) of the base portion (62) engaging the receiving flange (76) extending down from the head portion of the top portion of the diffuser.

With further reference to FIGS. 7 through 10, the engagement of the second conduit (68) of the base portion (62) to the receiving flange (76) which extends down from the head portion (70) of the top portion (64) of the diffuser forms an outlet passageway (80) that is in communication with the carbon dioxide extraction luer port (34) allowing for carbon dioxide exhaled by the patient to exit the posterior side of the mask body, pass through the primary port by entering into the outlet passageway (80) and exiting the respirator through the carbon dioxide extraction luer port (36). This is accomplished by the outlet port positioned at the head portion (70) of the top portion (64) of the diffuser being in communication with an interior space within the head portion (70) at the top portion (64) of the diffuser which in turn is in enclosed communication with the second conduit (68) of the base portion (62) of the diffuser.

With reference to FIG. 7, according to certain aspects of the present teaching, the base portion (62) of the diffuser may include a diffuser base body (40) and a diffuser middle body (30). According to this aspect of the present teaching, the first conduit (66) of the base portion (62) of the diffuser extends upward from the middle body (30) of the base portion (62) while the second conduit (68) of the base portion (62) of the diffuser extends upward from the base body (40) of the base portion (62) of the diffuser. Further according to this aspect of the present teaching, the first conduit (66) of may be integrated with or fitted within the middle body (30) of the base portion (62) of the diffuser and the second conduit (68) may be integrated with or fitted within the base body (40) of the base portion (62) of the diffuser.

FIG. 5 provides an exploded view of the respirator and its various component parts including the diffuser. As shown in FIG. 5, the diffuser top body (22) is attached to a diffuser retaining boss (28) and a CO₂ luer cap (24) and O₂ tube connection attaches to the diffuser top body (22). Transparent N95 filter membranes (16) attach to the side portions of the mask body (18). A diffuser middle body (30) attaches to the posterior side of the mark body (18) to the diffuser retaining boss (28) and a diffuser base body (32) attaches to the diffuser middle body (30) at the posterior side of the mask body. It is to be understood that the diffuser retaining boss (28) may or may not be present on the mask body.

The base body of the base portion of the diffuser includes chambers for the delivery of air and/or oxygen to the patient. According to certain aspects of the present disclosure, the base body of the base portion of the diffuser includes a first set of chambers, an associated first set of outlets in communication with the first set of chambers, a second set of chambers, and an associated second set of outlets in communication with the second set of chambers. An exemplary embodiment of a first set of chambers (82), an associated first set of outlets (48) in communication with the first set of chambers (82), a second set of chambers (84), and an associated second set of outlets (50) in communication with the second set of chambers (84) is shown in FIGS. 7, 11 and 12. The first set of outlets have a first size and the second set of outlets have a second size. According to certain aspects of the present teaching, the first size of the first set of outlets is smaller than the second size of the second set of outlets. This allows for the first set of chambers to provide a high velocity flow of air through the first set of outlets and the second set of chambers to provide a low velocity flow of air through the second set of outlets. In other embodiments, the first size of the first set of outlets is larger than the second size of the second set of outlets. In this embodiment, this allows the first set of chambers to provide a low velocity flow of air through the first set of outlets and the second set of chambers to provide a high velocity flow of air through the set of outlets. It is to be understood that the base portion of the diffuser may include additional sets of chambers and associated outlets of varying size allowing for flow of air through the outlets at varying velocities based on the size of the outlets.

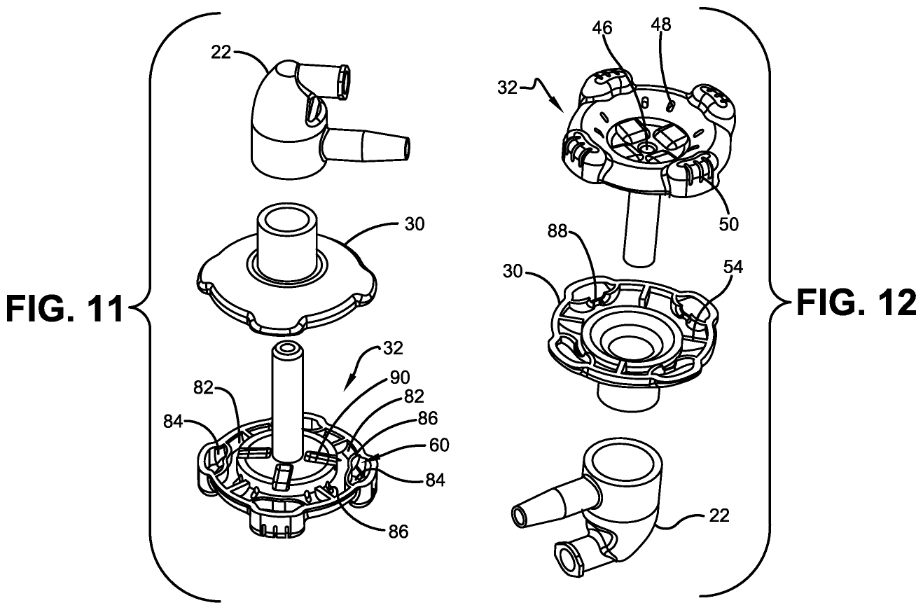

The chambers and corresponding outlets within the chambers in the base body of the base portion of the diffuser are separated from each other by dividers or barriers. An exemplary embodiment of dividers (86) separating the first set of chambers from each other and the first set of chambers from the second set of chambers is shown in FIG. 11. These chambers in the base body of the base portion of the diffuser are enclosed by a diffuser middle body which is fitted over the base body and is also a component of the base portion of the diffuser. An exemplary embodiment of a diffuser middle body (30) fitted over a base body (32) of the base portion (62) is illustrated in FIGS. 7, 11 and 12.

According to certain aspects of the present teaching, the first set of outlets are positioned in the first set of chambers radially at a first distance from a center of the base body (wherein the first set of chambers may be referred to as radial chambers) and the second set of outlets are positioned in the second set of chambers adjacent to the first set of chambers at a second distance from the base body. The first set of chambers (radial chambers) are positioned radially along the circumference of the base body and as such may be referred to as radial chambers. The second set of chambers are positioned at various points adjacent to the first set of chambers along the circumference of the base body. According to certain aspects of the present teaching, each radial chamber of the first set has positioned adjacent to it a single chamber of the second set. According to further aspects of the present teaching, the chambers of the second set may protrude outward from a general circumference of the base body and extend longitudinally beyond the general circumference of the base body. Accordingly, the second set of chambers may be referred to as protruding and longitudinally extending chambers.

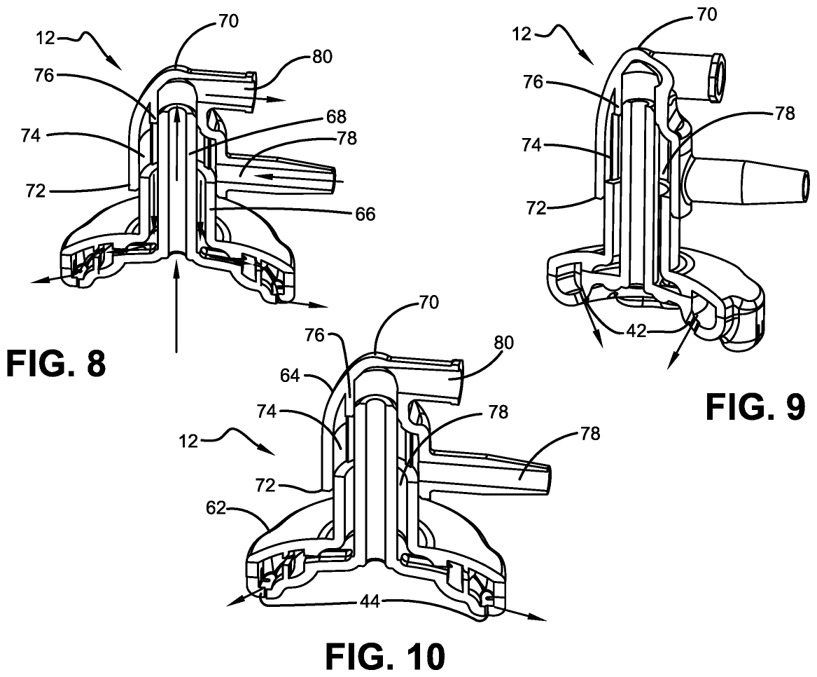

According to certain aspects of the present teaching, at least one air or oxygen pathway leads into each chamber of the first set of chambers. The air or oxygen pathways leading into the chambers of the first set of chambers is formed by the engagement of the diffuser middle body to the diffuser base body. According to certain aspects of the present teaching, the air or oxygen pathway is formed by a groove formed within a center structural rising of the base body wherein the center structural rising extends around a center circumference of the base body. This groove is enclosed by engaging the diffuser middle body over the top of the diffuser base body, thereby forming the pathway to the first set of chambers. An exemplary embodiment of an air or oxygen pathway (78) leading into the first set of chambers (82) and formed by the engagement of the diffuser middle body (30) to the diffuser base body (32) is illustrated within FIGS. 8 through 10.

By positioning the first set of chambers directly adjacent at a first distance from the air or oxygen pathways and the second set of chambers adjacent the first set of chambers at a second distance (greater than the first distance of the first set of chambers) from the air or oxygen pathways in the diffuser base body, the first set of chambers receives higher velocity flow of air or oxygen and the second set of chambers receives relatively lower velocity flow of air or oxygen. Moreover, the second set of chambers may include an interior divider which separates chambers of the second set from chambers of the first set. This interior divider may be of a lower profile or height relative to the profile or height of the outer or remaining walls forming the second chamber to allow air or oxygen to pass from an area over chambers of the first set to enter into an area denoted by chambers of the second set. An exemplary embodiment of this is shown in FIGS. 7 and 11. In other aspects of the present teaching, the interior divider of the second set of chambers may be of the same profile and height as the outer or remaining walls forming the second chamber. In such embodiments, the equivalent interior divider in the middle body which corresponds to the interior divider of the base body includes an aperture (88) allowing for air or oxygen to enter the second chamber as illustrated in FIG. 12.

A plurality of inlet channels may feed the first set of chambers (radial chambers) and the second set of chambers (the extended member chambers) allowing for high velocity flow of air to the first set of outlets in the first set of chambers and low velocity flow of air through the second set of outlets in the second set of chambers. An exemplary embodiment of inlet channels (90) is illustrated in FIGS. 7 and 11. Dividers or barriers positioned in the base body and middle body maintain airflow to each chamber or compartment. According to certain aspects of the present teaching, the dividers or barriers in the base body and the middle body are positioned to fit over and correspond to one another to complete the enclosure of the chambers or compartments and pathways when the base body and the middle body are engaged to one another. According to further aspects of the present teaching, at least one inlet channel feeds airflow to at least one first set of chambers and at least one second set of chambers. In other aspects of the present teaching, a single inlet channel feeds airflow to one chamber of the first set and one chamber of the second set. The base body and middle body of the base portion of the diffuser may include any number of chambers of the first set and the second set. The base body of the base portion of the diffuser may further include any number of first set of outlets within a first chamber or within the first chambers and any number of second set of outlets within a second chamber or within the second chambers. According to certain aspects of the present teaching, the base body and the middle body of the base portion of the diffuser includes four chambers of the first set and four chambers of the second set an exemplary embodiment of which is illustrated 5 through 12. According to certain aspects of the present teaching, a chamber of the first set may include a lesser number of outlets of the first set than the number of outlets of the second set in a corresponding chamber of the second set. According to further aspects of the present teaching, the first set of chambers includes two outlets of the first set and the second set of chambers includes three outlets of the second set. The outlets of the first set may or may not be the same size as the outlets of the second set. According to certain aspects of the present teaching, outlets of the first set are of a smaller size than outlets of the second set allowing for high velocity flow of air or oxygen through outlets of the first set relative to outlets of the second set. According to certain aspects of the present teaching, an outlet of the first set may have an oval or circular shape allowing for direct flow of air to a patient and an outlet of the second set may have a linear shape that extends along a side portion of the extended member chamber and which curves down to a bottom portion of the extended member chamber allowing for peripheral flow of air or oxygen to a patient. However, outlets of the first set and of the second set may be of any shape and of any orientation deemed suitable to a person of ordinary skill in the art including but not limited to curvilinear shapes or any geometric shape.

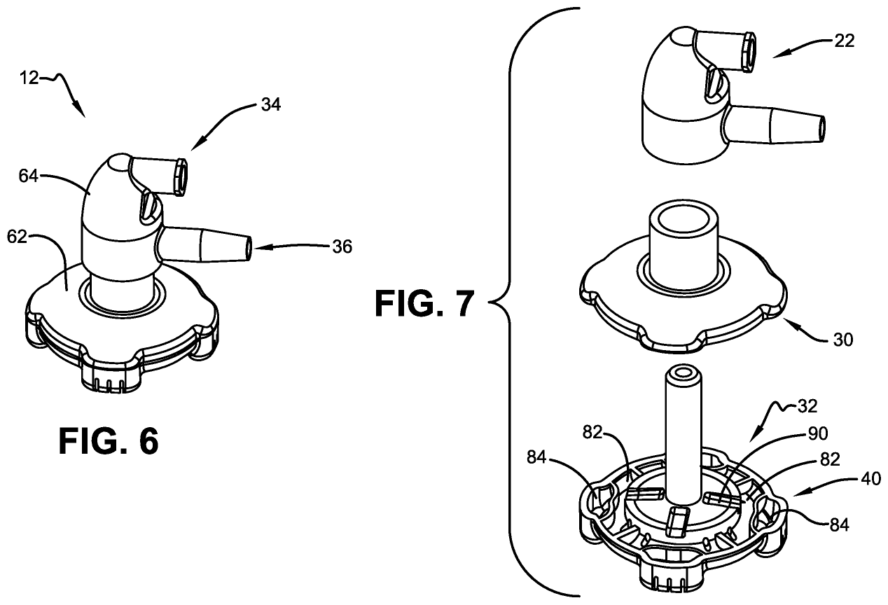

FIG. 6 illustrates the operation of the diffuser. As shown in FIG. 6, the diffuser includes O₂ chambers and outlets (second set of outlets shown) placed relatively close to the center portion of the base portion (62). This allows the diffuser to be rotated inside the mask body to accommodate medical and patient preference with respect to the positioning of the diffuser. The diffuser also includes a CO₂ extraction luer port (34) and an O₂ inlet port (36) allowing for the passage of air to and from the patient. FIG. 7 provides an exploded view of the components of the diffuser including the diffuser top body (22), the diffuser middle body (30) and the diffuser base body (40).

As mentioned above, FIGS. 8 through 10 provide cross-sectional views of the diffuser and illustrate how oxygen and carbon dioxide passes through the various conduits and passageways of the diffuser. As shown in FIGS. 9 and 10, there are high velocity oxygen outlets (42) and slow diffused oxygen outlets (44) on the diffuser base body (40). FIGS. 11 and 12 further describe the operation of the diffuser. As shown in FIG. 11, the diffuser base body (40) includes a diffused air chamber (60) and four inlet channels (88) which feed four separate chambers or compartments. The inlet channels are designed to distribute 25% oxygen to each compartment. FIG. 12 illustrates how the openings in each diffuser chamber wall are sized so that the ratio of oxygen between the focused oxygen jets (outlets of the first set) and the diffused oxygen outlets (52) (outlets of the second set) can be controlled. Also shown in the diffuser middle body (30) are barriers (also included in the diffuser base body which maintain airflow integrity to each compartment. Further, the diffuser base body (40) includes a carbon dioxide exhaust (46) outlet which allows carbon dioxide exhaled by a patient to travel through a conduit to exit the diffuser at the carbon dioxide extraction luer port. The diffuser base body (40) also includes a radial array of focused oxygen outlets (48) and diffused oxygen outlets (50).

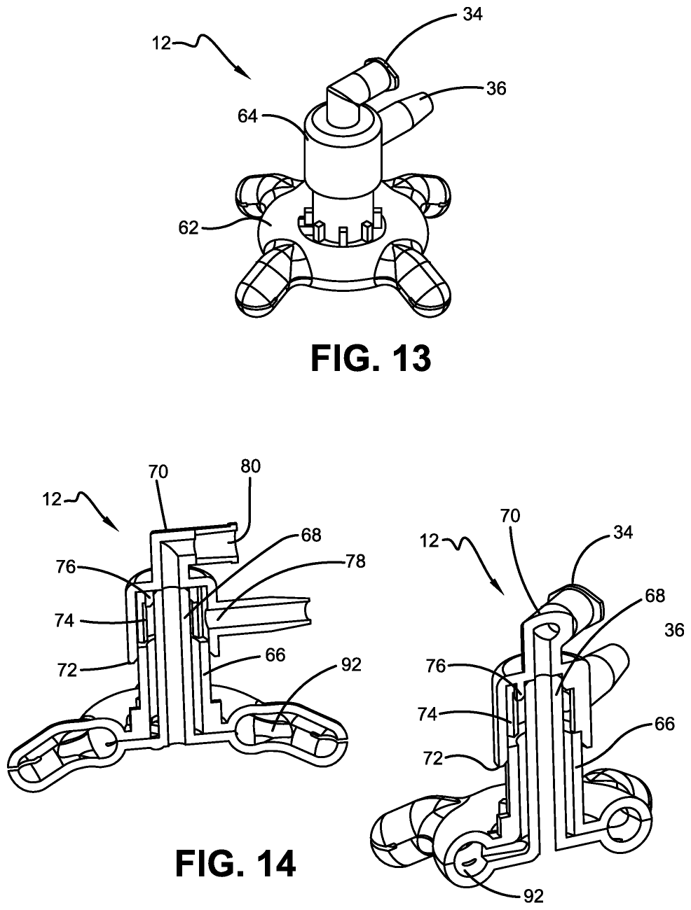

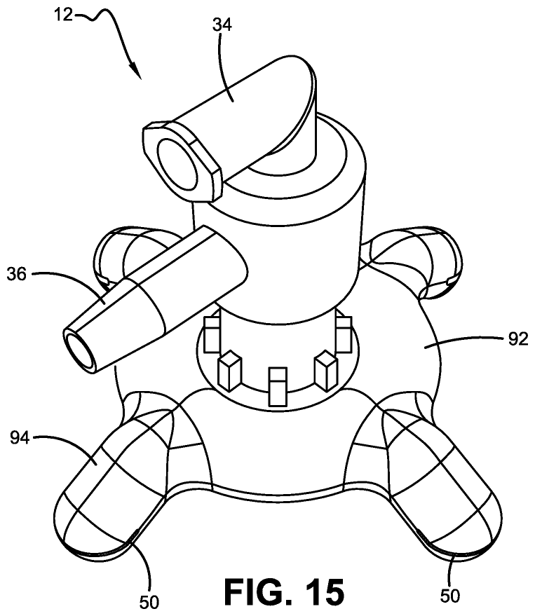

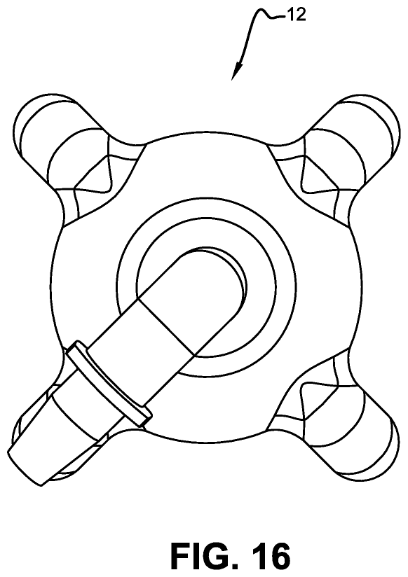

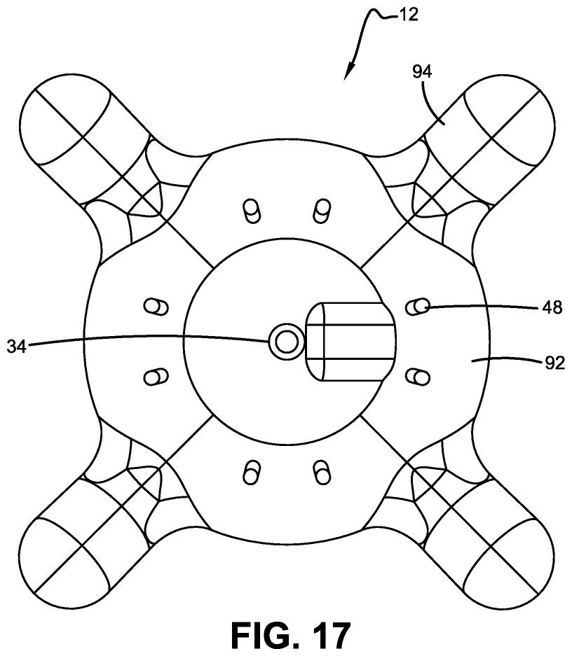

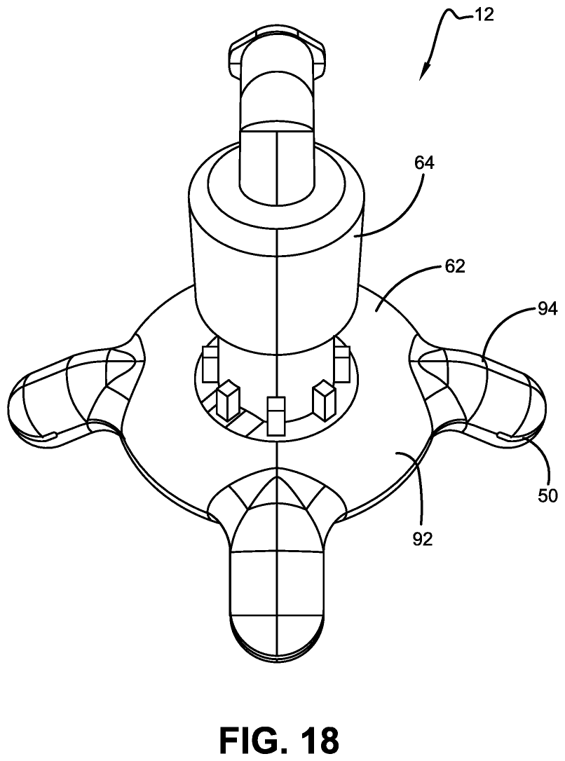

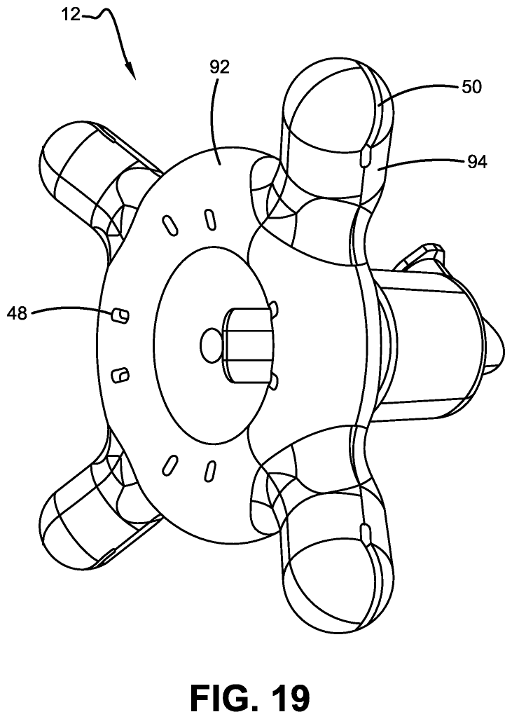

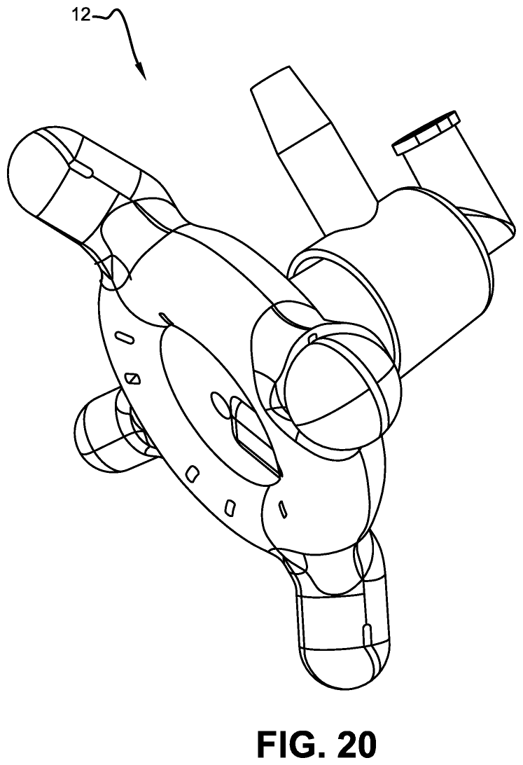

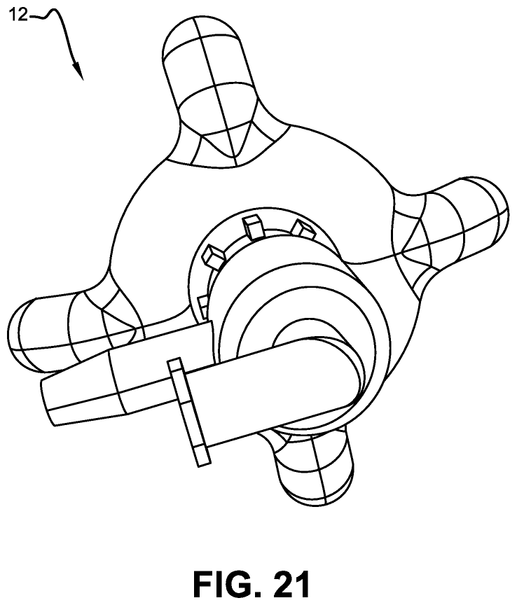

FIGS. 13 and 14 illustrate an alternative embodiment of a diffuser where the focused oxygen outlets (48) and the diffuser outlets (50) are fed from a single raceway that is enclosed. In this embodiment, the single raceway is formed from engagement of the base body and the middle body of the diffuser. The raceway extends around a circumference of the base portion and provides a conduit within the base portion allowing air flow or oxygen to feed the first set of outlets and the second set of outlets. The raceway may be of circular shape or any other geometric shape deemed suitable to a person of ordinary skill in the art. An exemplary embodiment of a raceway (92) is illustrated in 13 and 14. This embodiment of the diffuser further utilizes an extended arm which extends from the raceway to form the second set of chambers. The variations with respect to the first and second set of outlets discussed above apply to this embodiment of the diffuser. According to certain aspects of the present teaching, the first set of outlets positioned at the bottom side portion of the raceway are spaced in pairs about or a quarter of a circumferential distance apart from each other and circular or oval in shape whereas the second set of outlets are positioned along the end side of the extended arm chambers, are linear in shape and are oriented horizontally. However, as in other embodiments, the outlets within the first and second chambers (i.e., the raceway chamber and extended arm chambers) may be of any size, orientation and distance from one another as deemed suitable to a person of ordinary skill in the art to accommodate high velocity air or oxygen flow and low or diffused oxygen air or oxygen flow. FIGS. 15 to 21 provide various views of this alternative embodiment of the diffuser.

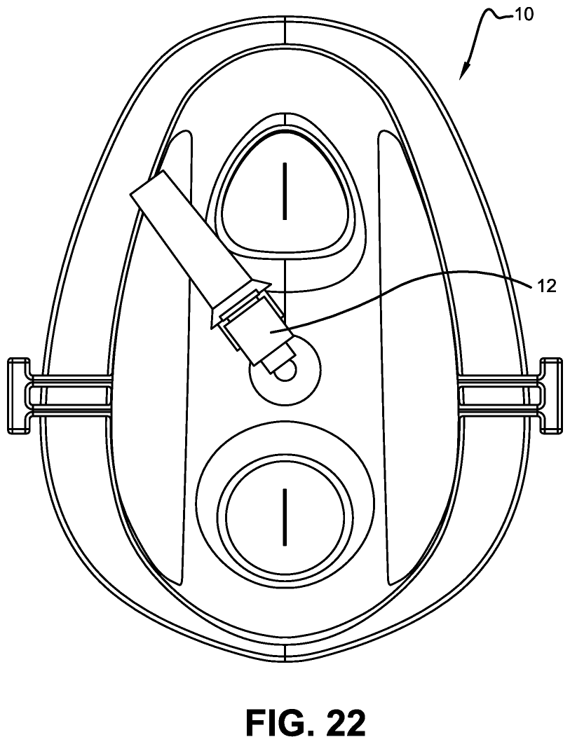

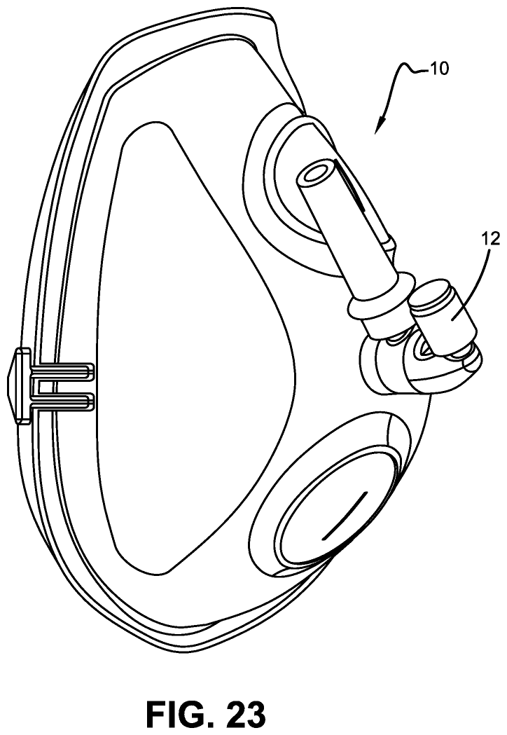

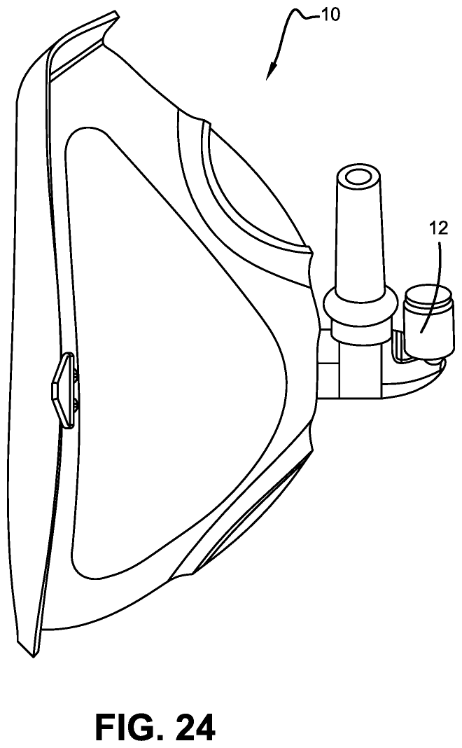

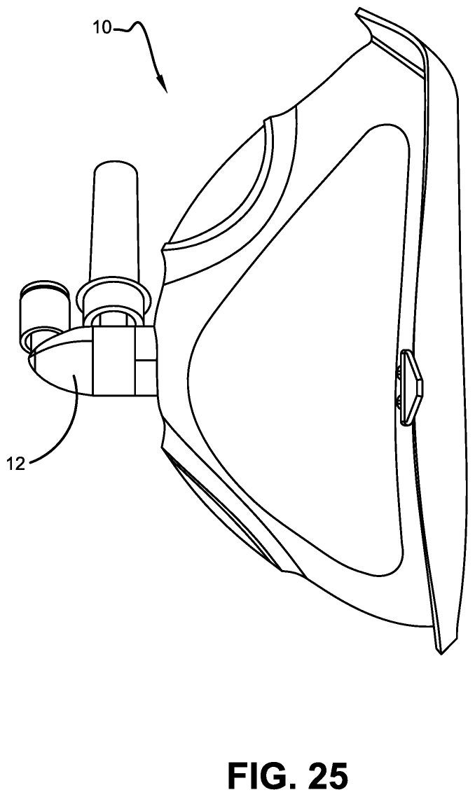

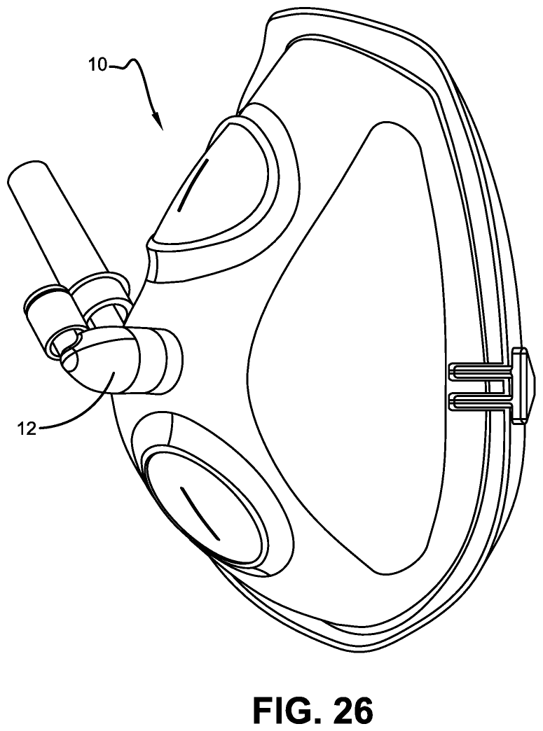

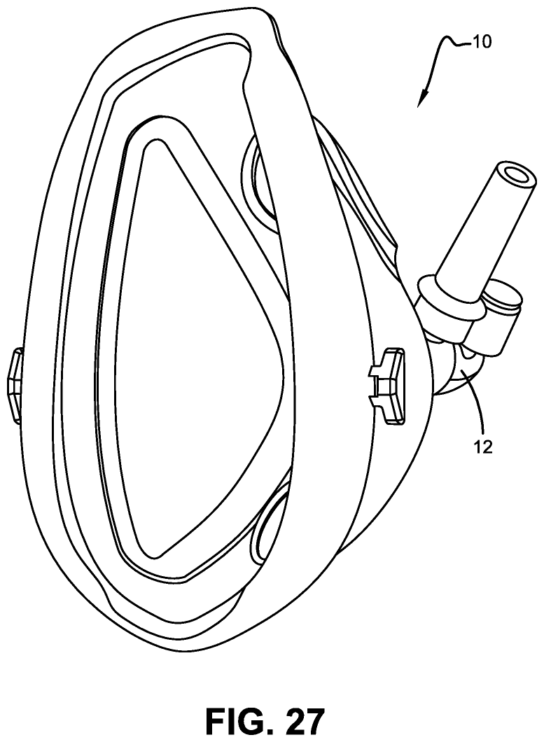

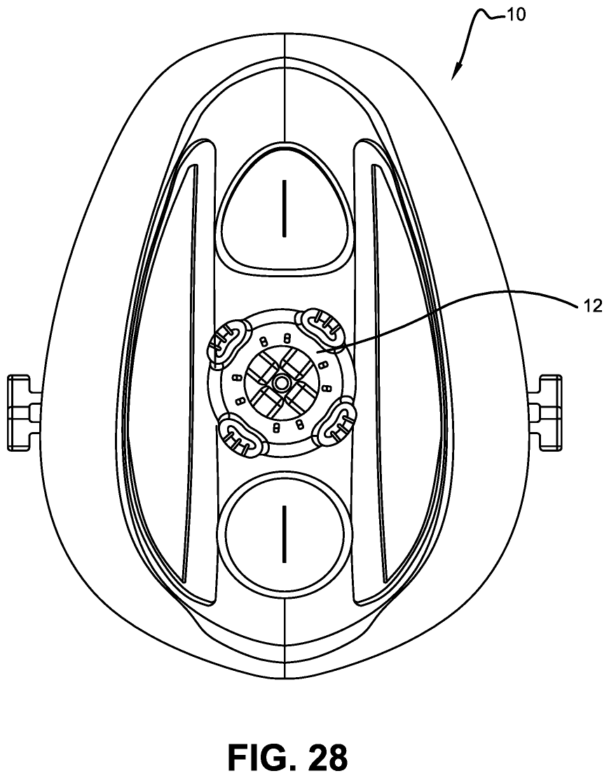

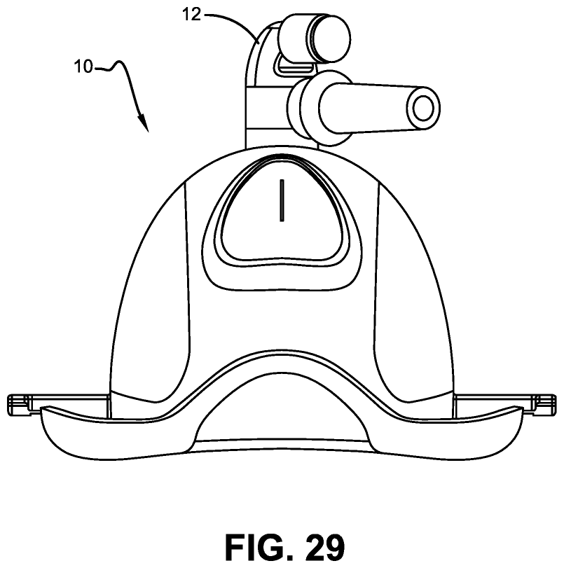

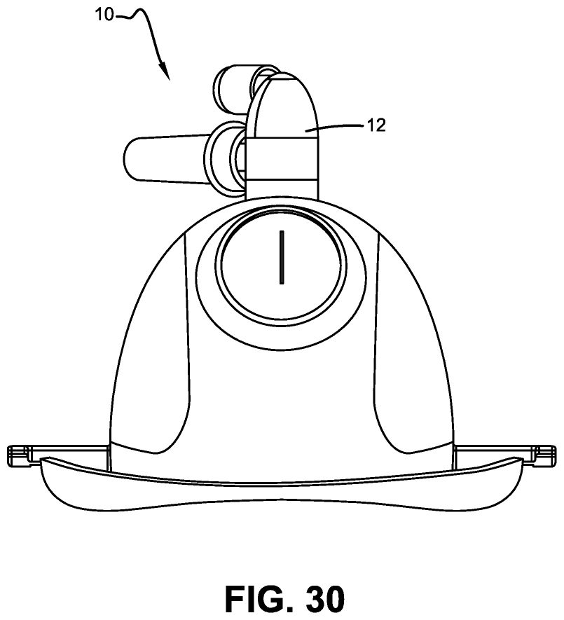

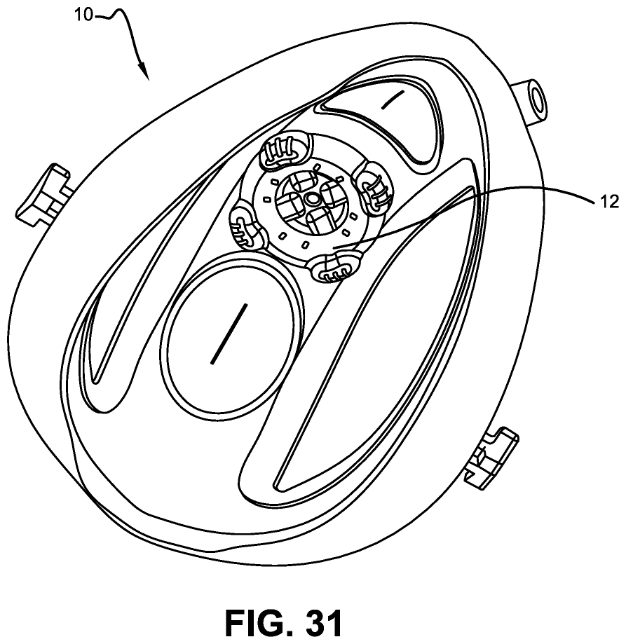

FIGS. 22 to 31 provide various views of the assembled respirator including the diffuser, filtering and sealing systems.

According to certain aspects of the present teaching, it is noted that the sealing membrane may be a self-sealing membrane. The self-sealing membrane may be made of silicone, a transparent thermoplastic elastomer or a medical grade rubber. In embodiments where a slit is provided in the sealing membrane (e.g., a single slit or a cross slit), an instrument is insertable through the slit. The slit may be formed in a membrane that is made from silicone. The membrane forms a seal (e.g., an elastomeric seal) around the instrument as the slit encapsulates and provides a seal around the instrument that is inserted through it. In certain embodiments, the slit, due to the nature of the membrane, is readily expandable to accommodate the size of the instrument that is inserted therethrough. The features of the slit described above may be achieved by the material employed to fabricate the membrane. In certain embodiments, the membrane in which the slit is formed is made from silicone. In further embodiments, the membrane in which the slit is formed is made from a resin or a thermoplastic elastomer, an example of which is Avient Versaflex™ CL2000X provided by Avient (Avon Lake, OH).

According to certain aspects of the present teaching, it is noted that the openings in the top and bottom anterior portion of the mask body may be capable of engaging any one of the following primary port adapters: an adapter for oxygen delivery, an adapter for nebulized medications/substances; an adapter for a PEEP valve attachment, an adapter for a device for taking breath samples with vacuum tubes, an adapter for an electronic device for measurement of spirometry/CO₂/temperature, an adapter for a humidifying and/or vaporizing device; an adapter for an electronic breathalyzer device, an adapter for an electronic nicotine delivery system, and an adapter for a UV light device.

As mentioned above, filter media material (e.g., a filter membrane) may be positioned over portions of the mask body and may be positioned over or cover at least the ports or apertures within the mask body. For example, in certain embodiments, the filter media material may be positioned to cover the side apertures and possibly the top anterior aperture and bottom anterior aperture of the mask body in other embodiments. In further embodiments, filter media material may cover the entire surface of the posterior portion of the mask body or may constitute the entire mask body. The filter media material may include a single or multiple microfiber filtering layers of varying thickness. The filter media material may further be made of polypropylene and polyester polyfiber compositions, or any other suitable material known to a person of ordinary skill in the art. In certain embodiments, the filter media may include an N95-rated filter media capable of providing a filtration efficiency of at least 95% against non-oily particles. In other embodiments, the filter media may comply with any other filtration standards within the industry and may have any filtration rating within the industry. The filter media material may be secured to the posterior portion of the mask body through ultrasonic welding, UV cured gluing or traditional gluing of the filter media material to the posterior portion of the mask body.

In a further embodiment of the present disclosure, the mask body of the filtering facepiece respirator may be positioned over an N95-rated or other filtration rated mask. However, the mask body may be positioned over a mask having any filtration rating. In further embodiments, the N95-rated or other filtration rated mask may include cutouts or apertures corresponding to apertures present within the mask body of the filtering facepiece respirator. The N-95-rated or other filtration rated mask may be secured to the posterior side portion of the of the mask body by ultrasonic welding, UV cured gluing, or traditional gluing of the edges of the N95-rated or other filtration rated mask to the outside edges of the mask body.

In a further embodiment of the present disclosure, the mask body of the filtering facepiece respirator is not made of silicone or a medical grade plastic but rather is made from a filter media material. The filter media material may include a single or multiple microfiber filtering layers of varying thickness. The filter media material may further be made of polypropylene and polyester polyfiber compositions, or any other suitable material known to a person of ordinary skill in the art. In certain embodiments, the filter media may be made from an N95 rated filter media capable of providing a filtration efficiency of at least 95% against non-oily particles. In other embodiments the filter media may be made from a material having a filtration rating other than N95. In certain embodiments, the filter media may be made from an electroceutical fabric. The filter media facepiece respirator may include any of the features described above with respect to the mask body including but not limited to the various apertures and structural components described above.

The apertures and ports described above and shown in the Figures may vary in size. The adapter fittings capable of engaging these ports including snap fittings, friction fittings, screw fittings any outer suitable fitting known to a person of skill in the art. The apertures and ports described above may further be provided in various combinations (e.g., with one, two or all three ports being present on the mask body) and arrangements on the mask body. The self-closing or self-sealing openings disclosed herein may be formed from a slit, cross slit or any other sized slit within the sealing material. The sealing material may be made from a self-sealing silicone material which is capable of forming a seal around an instrument which is passed through the opening. However, the self-sealing material may also be made from any type of self-sealing material (i.e., from materials other than silicone) including but not limited to elastomeric materials and polymeric materials. The sealing material and self-closing or self-sealing openings within the sealing material may be referred to as a membrane. In certain embodiments, the opening, due to the nature of the membrane, is readily expandable to accommodate the size of an instrument that is inserted therethrough. The features of the self-sealing or self-closing opening described above may be achieved by the material employed to fabricate the membrane. In certain embodiments, the membrane in which the opening is formed is made from silicone. In further embodiments, the membrane in which the opening is formed is made from a resin or a thermoplastic elastomer, an example of which is Avient Versaflex™ CL2000X provided by Avient (Avon Lake, OH). According to certain aspects of the present teaching, seal and self-sealing opening within the seal is capable of accommodating the insertion of multiple instruments.

The filtering facepiece respirator differs from and provides several advantages over current respirators. The present invention provides the utility and convenience of existing N95 respirator masks, while also providing novel openings allowing for insertion of medical instruments in the oropharynx. It also provides additional silicone, polypropylene, polycarbonate, nylon layers, and/or any other suitable plastic materials for enhanced sealing and filtration of micro particles around both the instrumenting device and the patient's face during medical procedures and other uses. Existing N95 respirator masks and masks of other filtration ratings do not work well because they have no way of creating a valid seal around the instrumenting device and the patient's face. The filtering facepiece respirator provides N95 functionality and improves on existing devices by creating additional filter/sealing layers around both the instrumenting device and the patient's face.

The respirator of the present invention may have alternative applications. The respirator may be used in any industry that requires putting on a mask for protection. The respirator may be used in conjunction with electronic devices for measuring CO₂, VO₂, temperature and other performance metrics. The device may be used in a recreational setting along with electronic nicotine delivery systems, breathalyzers and other auxiliary devices. Devices can be substituted into an aperture or port in the mask body to measure spirometry, exhaled breath temperature, capnography, oxygen concentrations, alcohol, ketones, pathological sampling and various other types of biological measurements. A device that can be substituted into an aperture or port in the mask body includes but is not limited to a breath test diagnostic tool for measuring gases like CO₂, hydrogen and other gases for diagnostic tests for lactose and fructose intolerances, bacterial overgrowth, H pylori etc. Devices can be substituted into an aperture or port in the mask body include a port adapter for delivery of oxygen, air, humidity, suction forces, nebulized medications, inhaled medication/agents (metered dose or otherwise) and other delivery systems. Devices can be substituted for the detachable plate to deliver UV light or other forms of treatment.

The filtering facepiece respirator disclosed herein may be worn by patients before procedures, during airway instrumentation, and after procedures, as herein described and disclosed. The filtering facepiece respirator distinguishes over previous masks by providing additional filter/sealing layers around both the instrumenting device and the patient's face.

The scope of the present disclosure further contemplates a system of apparatuses configured to implement various methods.

A first method contemplates a method of using the filtering facepiece respirator and/or diffuser of any of the embodiments disclosed herein. The method includes the steps of: providing the filtering facepiece respirator and/or diffuser; and applying the filtering facepiece respirator and/or diffuser over a face of a patient.

A second method contemplates a method of assembling any of the filtering facepiece disclosed herein. The method includes the steps of: providing the mask body; providing the diffuser; positioning the base portion of the diffuser under the port on the posterior side of the filtering facepiece respirator so that the first conduit and the second conduit of the base portion extend through the port towards the anterior side of the filtering facepiece respirator; and, engaging the top portion of the diffuser to the first conduit and the second conduit of the base portion of the diffuser on the anterior side of the filtering facepiece respirator.

A third method contemplates a method of making a filtering facepiece respirator of any of the embodiments disclosed herein. The method includes the steps of: providing the mask body having the anterior side, the posterior side, the middle portion, the first side portion, the second side portion, the top side portion, the bottom side portion and outer edge portions; forming an opening on the mask body constituting the port between the anterior side and the posterior side of the mask body; positioning the base portion of the diffuser under the port on the posterior side of the filtering facepiece respirator so that the first conduit and the second conduit of the base portion extend through the port towards the anterior side of the filtering facepiece respirator; and, engaging the top portion of the diffuser to the first conduit and the second conduit of the base portion of the diffuser on the anterior side of the filtering facepiece respirator.

A fourth method contemplates a method of assembling a diffuser of any of the embodiments disclosed herein. The method includes the steps of: providing a diffuser top portion; providing a diffuser bottom portion including a middle body and a base body; engaging the middle body to the base body to form the bottom portion of the diffuser; engaging the top portion to the bottom portion to form an assembled diffuser.

A fifth method contemplates a method of making a diffuser of any of the embodiments disclosed herein. The method includes the steps of: providing a base portion including a base body and a middle body wherein the base body is formed by forming a first conduit, at least one inlet channel, at least one set of chambers, and at least one outlet in the base body; forming a second conduit in the middle body that is capable of being fitted over the first conduit of the base body; engaging the middle body to the base body to form the base portion of the diffuser; providing a top portion, wherein the top portion is formed by forming a receiving conduit capable of engaging the first conduit of the base portion and forming a receiving flange capable of engaging the second conduit of the middle portion; and engaging the base portion to the top portion of the diffuser.

### LISTING OF REFERENCE NUMBERS

1. filtering facepiece respirator (10)
2. diffuser (12)
3. stretchy seal with self-closing opening (14)
4. transparent N95 filter membranes (16)
5. face mask body or mask body (18)
6. strap hooks (20)
7. diffuser top body (22)
8. CO₂ luer cap (24)
9. O₂ tube connection (26)
10. diffuser retaining boss (28)
11. diffuser middle body (30)
12. diffuser base body (32)
13. CO₂ extraction luer port (34)
14. O₂ inlet port (36)
15. diffuser middle body (38)
16. diffuser base body (40)
17. focused high velocity O₂ outlets (first set of outlets) (42)
18. slow diffused O₂ outlets (second set of outlets) (44)
19. diffuser CO₂ exhaust (46)
20. radial array of focused O₂ outlets (first set of outlets) (48)
21. diffused O₂ outlets (second set of outlets) (50)
22. openings in diffuser chamber wall (52)
23. barriers in the middle and base bodies in the diffuser (54)
24. diffused air chamber (56)
25. inlet channels in diffuser body (58)
26. diffused air chamber (60)
27. base portion of diffuser (62)
28. top portion of diffuser (64)
29. first conduit of diffuser base portion (66)
30. second conduit of diffuser base portion (68)
31. head portion of top portion of diffuser (70)
32. bottom portion of top portion of diffuser (72)
33. receiving conduit of top portion of diffuser (74)
34. receiving flange of top portion of diffuser (76)
35. air or oxygen pathway (78)
36. outlet passageway (80)
37. first set of chambers in diffuser (82)
38. second set of chambers in diffuser (84)
39. dividers in diffuser (86)
40. aperture in dividers in diffuser (88)
41. inlet channels in diffuser (90)
42. raceway in diffuser (92)
43. extended arm in diffuser (94)

Provided below is a set of clauses describing the disclosure set forth herein:

Clause 1—A filtering facepiece respirator including: a mask body having an anterior side, a posterior side, a middle portion, a first side portion, a second side portion, a top side portion, a bottom side portion and outer edge portions; a port positioned on the mask body; a diffuser positioned over the port on the mask body, wherein the diffuser comprises an inlet port, inlet port passageways, an outlet port and outlet port passageways allowing for the inlet and outlet of air, and wherein the inlet port passageways and outlet port passageways are separate and closed from each other preventing the mixing of inlet air and outlet air.

Clause 2—The filtering facepiece respirator of Clause 1, wherein the diffuser includes a base portion and a top portion which are engaged to each other.

Clause 3—The filtering facepiece respirator of Clause 1 or Clause 2, wherein the base portion of the diffuser includes a first conduit which extends upward from the base portion and a second conduit positioned within the first conduit which extends upward from the base portion.

Clause 4—The filtering facepiece respirator of any of the preceding Clauses, wherein the top portion of the diffuser includes a head portion and a bottom portion, a receiving conduit which extends upward towards the head portion of the top portion of the diffuser and a receiving flange integrated within the receiving conduit which extends downward from the head portion of the top portion of the diffuser.

Clause 5—The filtering facepiece respirator of any of the preceding Clauses, wherein the first conduit of the base portion of the diffuser engages the receiving conduit of the top portion of the diffuser and the second conduit of the base portion of the diffuser engages the receiving flange which extends downward from the head portion of the top portion of the diffuser.

Clause 6—The filtering facepiece respirator of any of the preceding Clauses, wherein the inlet passageway is formed from the engagement between first conduit of the base portion of the diffuser and the receiving conduit of the top portion of the diffuser, wherein the inlet passageway is formed from an inlet space provided between the first conduit of the base portion and the second conduit of the base portion, and wherein the inlet space is enclosed by the second conduit of the base portion engaging the receiving flange which extends down from the head portion of the top portion of the diffuser.

Clause 7—The filtering facepiece respirator of any of the preceding Clauses, wherein the top portion of the diffuser comprises an inlet port which provides an inlet passageway in communication with the inlet space provided between the first conduit of the base portion and the second conduit of the base portion and enclosed by the second conduit of the base portion engaging the second receiving flange extending down from the head portion of the top portion of the diffuser.

Clause 8—The filtering facepiece respirator of any of the preceding Clauses, wherein the outlet passageway is formed from the engagement of the second conduit of the base portion to the receiving flange which extends down from the head portion of the top portion of the diffuser, wherein the head portion of the top portion of the diffuser comprises an outlet port in communication with a space within the head portion of the top portion of the diffuser and within the second conduit of the base portion of the diffuser.

Clause 9—The filtering facepiece respirator of any of the preceding Clauses, wherein the base portion of the diffuser comprises a base body and a middle body and wherein the top portion of the diffuser comprises a top body, wherein the first conduit of the base portion extends upward from the middle body and wherein the second conduit of the base portion extends from the base body.

Clause 10—The filtering facepiece respirator of any of the preceding Clauses, wherein the base body of the base portion of the diffuser comprises a first set of chambers, a second set of chambers, a first set of outlets and a second set of outlets, wherein the first set of outlets have a first size and the second set of outlets have a second size, wherein the first size of the first set of outlets is smaller than the second size of the second set of outlets, wherein the first set of chambers allows for high velocity flow of air through the first set of outlets and wherein the second set of chambers allows for low velocity flow of air through the second set of outlets.

Clause 11—The filtering facepiece respirator of any of the preceding Clauses, wherein the first set of outlets are positioned radially a first distance from a center of the base body within the first set of chambers, wherein the first set of chambers include radial compartments, wherein the second set of chambers include extended chamber members and wherein the second set of outlets are positioned within a plurality of extended chamber members positioned a second distance from the center of the base body.

Clause 12—The filtering facepiece respirator of any of the preceding Clauses, wherein a plurality of inlet channels feed compartments formed by the extended chamber members to allow for low velocity flow of air through the second set of outlets, wherein barriers positioned within the middle body and the base body maintain airflow integrity to each compartment.

Clause 13—The filtering facepiece respirator of any of the preceding Clauses, wherein the base portion of the diffuser comprises a single raceway formed from engagement of the base body and the middle body, wherein the raceway extends around a circumference of the base portion and provides a conduit within the base portion allowing air flow to feed the first set of outlets and the second set of outlets.

Clause 14—The filtering facepiece respirator of any of the preceding Clauses, wherein the top portion and the base portion of the diffuser are rotatable with respect to each other and wherein the base portion of the diffuser is rotatable within the mask body.

Clause 15—The filtering facepiece respirator of any of the preceding Clauses, wherein the base portion of the diffuser is positioned under the port on the posterior side of the mask body and wherein the first conduit of the base portion of the diffuser extends upward from the posterior side of the mask body through the port to the anterior side of the mask body.

Clause 16—The filtering facepiece respirator of any of the preceding Clauses, wherein the first side portion of the mask body includes a first opening and the second side portion of the mask body including a second opening, wherein the first opening and/or the second opening on the first and second side of the mask body is fitted with a removable filter membrane, a seal or a seal including a self-sealing opening.

Clause 17—The filtering facepiece respirator of any of the preceding Clauses, wherein the top side portion of the mask body includes an opening and the bottom side portion of the mask body includes an opening, wherein the top side portion and/or the bottom side portion of the mask body is fitted with a removable filter membrane, a seal or a seal including a self-sealing opening.

Clause 18—The filtering facepiece respirator of any of the preceding Clauses, wherein the top side portion of the mask body includes an opening and the bottom side portion of the mask body includes an opening, wherein the top side portion and/or the bottom side portion of the mask body is fitted with a removable filter membrane, a seal or a seal including a self-sealing opening.

Clause 19—The filtering facepiece respirator of any of the preceding Clauses, wherein the mask body includes strap hooks.

Clause 20—A method of using the filtering facepiece respirator of any of the preceding Clauses including: providing the filtering facepiece respirator; and applying the filtering facepiece respirator over a face of a patient.

Clause 21—A method of assembling the filtering facepiece respirator of any of the preceding Clauses, including: providing the mask body; providing the diffuser; positioning the base portion of the diffuser under the port on the posterior side of the filtering facepiece respirator so that the first conduit and the second conduit of the base portion extend through the port towards the anterior side of the filtering facepiece respirator; and, engaging the top portion of the diffuser to the first conduit and the second conduit of the base portion of the diffuser on the anterior side of the filtering facepiece respirator.

Clause 22—A method of making a filtering facepiece respirator of claim 3 including: providing the mask body having the anterior side, the posterior side, the middle portion, the first side portion, the second side portion, the top side portion, the bottom side portion and outer edge portions; forming an opening on the mask body constituting the port between the anterior side and the posterior side of the mask body; positioning the base portion of the diffuser under the port on the posterior side of the filtering facepiece respirator so that the first conduit and the second conduit of the base portion extend through the port towards the anterior side of the filtering facepiece respirator; and, engaging the top portion of the diffuser to the first conduit and the second conduit of the base portion of the diffuser on the anterior side of the filtering facepiece respirator.

While the respirator or mask provided herein has been described in connection with various illustrative embodiments, it is to be understood that other similar embodiments may be used, or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the respirator or mask should not be limited to any single embodiment, but rather construed in breadth and scope in accordance with the recitations of the appended claims.

What is claimed is:

1. A filtering facepiece respirator comprising:
a mask body having an anterior side, a posterior side, a middle portion, a first side portion, a second side portion, a top side portion, a bottom side portion and outer edge portions;
a port positioned on the mask body;
a diffuser positioned over the port on the mask body, wherein the diffuser comprises an inlet port, inlet port passageways, an outlet port and outlet port passageways allowing for the inlet and outlet of air, and wherein the inlet port passageways and outlet port passageways are separate and closed from each other preventing the mixing of inlet air and outlet air.

2. The filtering facepiece respirator of claim 1, wherein the diffuser comprises a base portion and a top portion which are engaged to each other.

3. The filtering facepiece respirator of claim 2, wherein the base portion of the diffuser comprises a first conduit which extends upward from the base portion and a second conduit positioned within the first conduit which extends upward from the base portion.

4. The filtering facepiece respirator of claim 3, wherein the top portion of the diffuser comprises a head portion and a bottom portion, a receiving conduit which extends upward towards the head portion of the top portion of the diffuser and a receiving flange integrated within the receiving conduit which extends downward from the head portion of the top portion of the diffuser.

5. The filtering facepiece respirator of claim 4, wherein the first conduit of the base portion of the diffuser engages the receiving conduit of the top portion of the diffuser and the second conduit of the base portion of the diffuser engages the second receiving conduit which extends downward from the head portion of the top portion of the diffuser.

6. The filtering facepiece respirator of claim 5, wherein the inlet passageway is formed from the engagement between first conduit of the base portion of the diffuser and the receiving conduit of the top portion of the diffuser, wherein the inlet passageway is formed from an inlet space provided between the first conduit of the base portion and the second conduit of the base portion, and wherein the inlet space is enclosed by the second conduit of the base portion engaging the receiving flange which extends down from the head portion of the top portion of the diffuser.

7. The filtering facepiece respirator of claim 6, wherein the top portion of the diffuser comprises an inlet port which provides an inlet passageway in communication with the inlet space provided between the first conduit of the base portion and the second conduit of the base portion and enclosed by the second conduit of the base portion engaging the receiving flange extending down from the head portion of the top portion of the diffuser.

8. The filtering facepiece respirator of claim 7, wherein the outlet passageway is formed from the engagement of the second conduit of the base portion to the receiving flange which extends down from the head portion of the top portion of the diffuser, wherein the head portion of the top portion of the diffuser comprises an outlet port in communication with a space within the head portion of the top portion of the diffuser and within the second conduit of the base portion of the diffuser.

9. The filtering facepiece respirator of claim 8, wherein the base portion of the diffuser comprises a base body and a middle body and wherein the top portion of the diffuser comprises a top body, wherein the first conduit of the base portion extends upward from the middle body and wherein the second conduit of the base portion extends from the base body.

10. The filtering facepiece respirator of claim 9, wherein the base body of the base portion of the diffuser comprises a first set of chambers, a second set of chambers, a first set of outlets and a second set of outlets, wherein the first set of outlets have a first size and the second set of outlets have a second size, wherein the first size of the first set of outlets is smaller than the second size of the second set of outlets, wherein the first set of chambers allows for high velocity flow of air through the first set of outlets and wherein the second set of chambers allows for low velocity flow of air through the second set of outlets.

11. The filtering facepiece respirator of claim 10, wherein the first set of outlets are positioned radially a first distance from a center of the base body within the first set of chambers, wherein the first set of chambers comprise radial compartments, wherein the second set of chambers comprise extended chamber members and wherein the second set of outlets are positioned within a plurality of extended chamber members positioned a second distance from the center of the base body.

12. The filtering facepiece respirator of claim 11, wherein a plurality of inlet channels feed compartments formed by the extended chamber members to allow for low velocity flow of air through the second set of outlets, wherein barriers positioned within the middle body and the base body maintain airflow integrity to each compartment.

13. The filtering facepiece respirator of claim 12, wherein the base portion of the diffuser comprises a single raceway formed from engagement of the base body and the middle body, wherein the raceway extends around a circumference of the base portion and provides a conduit within the base portion allowing air flow to feed the first set of outlets and the second set of outlets.

14. The filtering facepiece respirator of claim 2, wherein the top portion and the base portion of the diffuser are rotatable with respect to each other and wherein the base portion of the diffuser is rotatable within the mask body.

15. The filtering facepiece respirator of claim 3, wherein the base portion of the diffuser is positioned under the port on the posterior side of the mask body and wherein the first conduit of the base portion of the diffuser extends upward from the posterior side of the mask body through the port to the anterior side of the mask body.

16. The filtering facepiece respirator of claim 15, wherein the first side portion of the mask body comprises a first opening and the second side portion of the mask body comprises a second opening, wherein the first opening and/or the second opening on the first and second side of the mask body is fitted with a removable filter membrane, a seal or a seal comprising a self-sealing opening.

17. The filtering facepiece respirator of claim 16, wherein the top side portion of the mask body comprises an opening and the bottom side portion of the mask body comprises an opening, wherein the top side portion and/or the bottom side portion of the mask body is fitted with a removable filter membrane, a seal or a seal comprising a self-sealing opening.

18. The filtering facepiece respirator of claim 15, wherein the top side portion of the mask body comprises an opening and the bottom side portion of the mask body comprises an opening, wherein the top side portion and/or the bottom side portion of the mask body is fitted with a removable filter membrane, a seal or a seal comprising a self-sealing opening.

19. The filtering facepiece respirator of claim 1, wherein the mask body comprises strap hooks.

20. A method of using the filtering facepiece respirator of claim 1 comprising:
providing the filtering facepiece respirator; and
applying the filtering facepiece respirator over a face of a patient.

21. A method of assembling the filtering facepiece respirator of claim 3, comprising:
providing the mask body;
providing the diffuser;
positioning the base portion of the diffuser under the port on the posterior side of the filtering facepiece respirator so that the first conduit and the second conduit of the base portion extend through the port towards the anterior side of the filtering facepiece respirator; and,
engaging the top portion of the diffuser to the first conduit and the second conduit of the base portion of the diffuser on the anterior side of the filtering facepiece respirator.

22. A method of making a filtering facepiece respirator of claim 3 comprising:
providing the mask body having the anterior side, the posterior side, the middle portion, the first side portion, the second side portion, the top side portion, the bottom side portion and outer edge portions;
forming an opening on the mask body constituting the port between the anterior side and the posterior side of the mask body;
positioning the base portion of the diffuser under the port on the posterior side of the filtering facepiece respirator so that the first conduit and the second conduit of the base portion extend through the port towards the anterior side of the filtering facepiece respirator; and,
engaging the top portion of the diffuser to the first conduit and the second conduit of the base portion of the diffuser on the anterior side of the filtering facepiece respirator.
